(19) United States
(12) Patent Application Publication
(10) Pub. No.: US 2015/0098444 A1
(43) Pub. Date: Apr. 9, 2015

(54) LARGE SCALE ANTENNA SYSTEM WITH OVERLAYING SMALL CELLS

(71) Applicant: ALCATEL-LUCENT USA INC, Murray Hill, NJ (US)

(72) Inventors: Thomas L. Marzetta, Summit, NJ (US); Hong Yang, Ledgewood, NJ (US)

(73) Assignee: ALCATEL-LUCENT USA INC, Murray Hill, NJ (US)

(21) Appl. No.: 14/048,728

(22) Filed: Oct. 8, 2013

(51) Int. Cl. H04L 5/00; H04W 36/00

(52) U.S. Cl. CPC H04L 5/0073; H04L 5/0051; H04W 36/0072
USPC 370/331; 370/329

(57) ABSTRACT

A large-scale antenna system (LSAS) base station transmits one or more first signals on one or more first channels corresponding to one or more first access terminals associated with the LSAS base station concurrently with nulling one or more second channels corresponding to one or more second access terminals associated with one or more small cells. The first signal(s) is/are transmitted synchronously with the second signal(s) transmitted by the small cell(s).

### BACKGROUND

1. Field of the Disclosure

The present disclosure relates generally to wireless communication systems and, in particular, to large-scale antenna systems in wireless communication systems.

2. Description of the Related Art

Large-scale antenna systems (LSAS) use a large number of service antennas to support uplink and downlink transmissions between a base station and access terminals. An LSAS system may also be referred to as a massive multiple-in-multiple-out (MIMO) system, a large-scale MIMO system, a hyper-MIMO system, or an Argos system. By keeping the number of service antennas larger than the number of access terminals, the LSAS base station can concurrently transmit signals to each access terminal using separate data-bearing beams. The LSAS base station can also separate multiple data-bearing signals that are concurrently received from each access terminal. Wireless communication systems that implement LSAS are expected to have a number of advantages over conventional wireless communication systems, such as Long Term Evolution (LTE) systems. For example, an LSAS system is expected to provide a spectral efficiency that is 1-2 orders of magnitude better than in conventional LTE systems, require a lower radiated power, and provide uniform quality of service for all users within the cells served by the LSAS base station.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a wireless communication system according to some embodiments.

FIG. 2 is a block diagram of an example of a TDD channel according to some embodiments.

FIG. 3 is a block diagram of a wireless communication system according to some embodiments.

FIG. 4 is a flow diagram of a method for concurrent transmission and reception in a wireless communication system that includes an LSAS base station and one or more overlying small cells according to some embodiments.

### DETAILED DESCRIPTION

As discussed herein, LSAS systems are expected to have a number of advantages over conventional wireless communication systems that use relatively small numbers of antennas. Although these advantages reduce the motivation for supplementing coverage in the LSAS system with overlaying small cell coverage, adding small cells to an LSAS system may be used to provide enhanced (e.g., higher speed) service to some access terminals. Overlaying small cell coverage with coverage provided by an LSAS base station may also improve the efficiency of the system by reducing the transmission power per bit. However, these advantages may be reduced or eliminated if the LSAS system and the overlaying small cells interfere with each other. Avoiding interference by allocating a different band of frequencies to the small cells would require additional, and costly, spectrum. Moreover, overlaying small cell deployments may require additional transceivers in the access terminal to support communication with both the LSAS system and the small cells.

An LSAS base station can reduce or eliminate interference between the LSAS base station and overlaying small cells by nulling spatial channels for access terminals associated with the overlaying small cells while receiving or transmitting data over channels for access terminals associated with the LSAS base station. Some embodiments of the LSAS base station may partition the access terminals into a first set that communicates with the LSAS base station and a second set that communicates with the small cells. The first set and the second set of access terminals communicate with their respective access points using a synchronous slot structure. Each access terminal in the second set communicates with only one of the small cells. The LSAS base station allocates first channels and second channels to the first set and the second set, respectively, using channel state information received from the first and second sets of access terminals. The LSAS base station may then communicate with the first set of access terminals in a spatial diversity subspace that is orthogonal to a spatial diversity subspace spanned by the second channels allocated to the second set of access terminals. For example, downlink transmission from the LSAS base station may be beamed to the first set of access terminals and nulls may be directed at the second set of access terminals. For another example, the LSAS base station may null signals received on the second channels while decoding signals received over the first channels. Uplink or downlink transmission power control may also be used to reduce interference between transmissions associated with the first set of access terminals and the second set of access terminals.

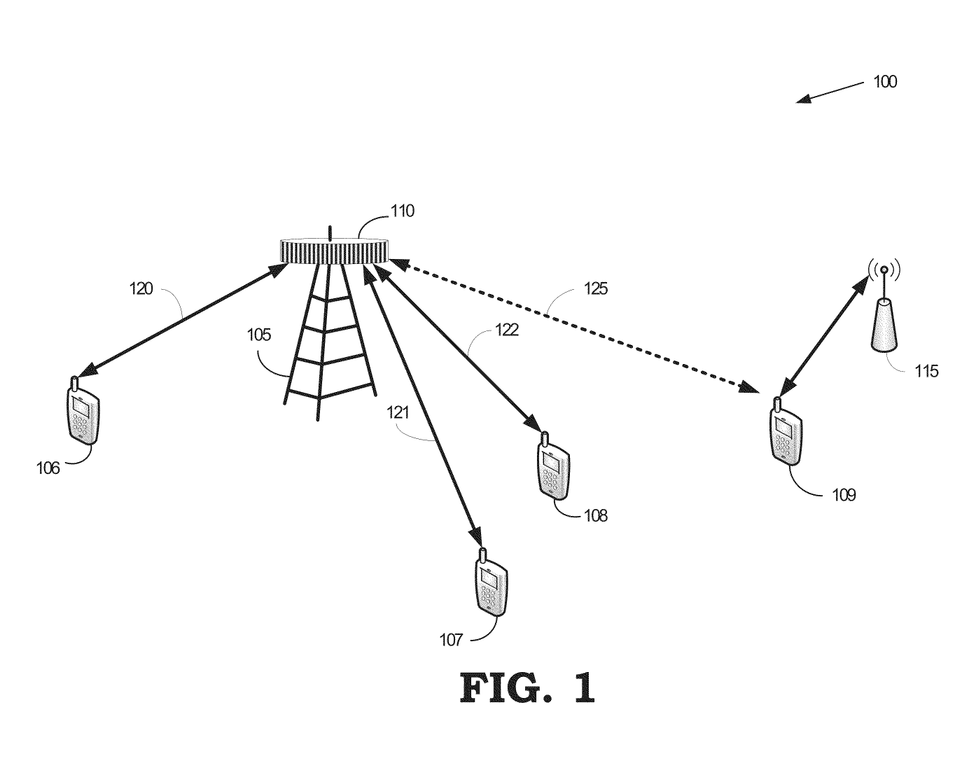

FIG. 1 is a diagram of a wireless communication system 100 according to some embodiments. The wireless communication system 100 includes one or more LSAS base stations 105 for providing wireless connectivity to access terminals 106, 107, 108, 109 (collectively referred to as “the access terminals 106-109”) within a corresponding geographic area or cell. The LSAS base station 105 includes an antenna array 110 that includes a large number of antennas (individual antennas not indicated by separate reference numerals in the interest of clarity) for transmitting or receiving uplink or downlink signals. As used herein, the phrase “large number” indicates that the number of antennas in the antenna array 110 is larger than the number of access terminals 106-109 associated with the LSAS base station 105. For example, the number of antennas in the antenna array 110 may be 3-5 times larger than the maximum number of access terminals 106-109 associated with the LSAS base station 105. For example, the antenna array 110 may include 128 antennas for providing service to 20-30 access terminals 106-109. Some embodiments of the wireless communication system 100 may maintain the ratio of antennas to access terminals 106-109 at or above a threshold ratio using admission control techniques, limiting the number of unique scrambling codes or identifiers for pilot signals, and the like.

The LSAS base station 105 and the access terminals 106-109 communicate using a time division duplex (TDD) protocol. Timing of the LSAS base station 105 and the access terminal 106-109 may therefore be synchronized so that uplink (or reverse link) signals and downlink (or forward link) signals can be transmitted between the LSAS base station 105 and the access terminals 106-109 during different portions of a time slot. Techniques for synchronizing the timing of the LSAS base station 105 and the access terminals 106-109 are known in the art and in the interest of clarity are not discussed herein.

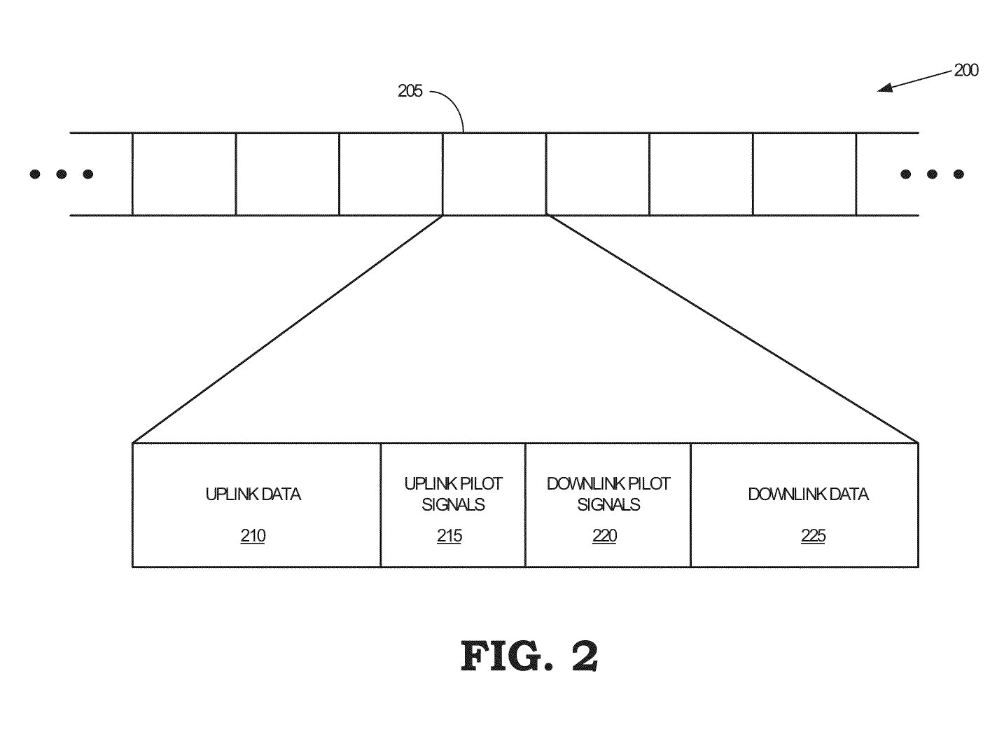

FIG. 2 is a block diagram of an example of a TDD channel 200 according to some embodiments. The TDD channel 200 uses the same frequency band(s) for the uplink and downlink channels. The TDD channel 200 includes a plurality of time slots 205 (only one indicated by a numeral in FIG. 2) that can be used for uplink or downlink transmission. Some embodiments of the time slot 205 include a first portion 210 that is reserved for transmitting uplink data (e.g., from an access terminal to an LSAS base station), a second portion 215 that is reserved for transmitting uplink pilot signals, a third portion 220 that is reserved for transmitting downlink pilot signals (e.g., from the base station to the access terminal), and a fourth portion 225 that is reserved for transmitting downlink data.

A duration of the time slots 205 may be less than or equal to a coherence interval that is determined assuming that the relative positions of the access terminal and the LSAS base station do not change by more than approximately ¼ of a wavelength of the uplink or downlink signals during the coherence interval. Propagation channels between the LSAS base station and the access terminal are therefore approximately constant during the time slot 205.

Pilot transmission in the portion 215 is preceded by up-link data transmission in the portion 210. In some embodiments, access terminals may transmit message-bearing signals concurrently using the same time/frequency resources, subject to possible power-control rules. The LSAS base station can estimate CSI for both the uplink and the downlink channels in the time slot 205 using the uplink pilot signals in the portion 215 because the duration of each time slot 205 is limited to be less than or approximately equal to the coherence interval, as discussed above. This property is known as TDD reciprocity. The LSAS base station may therefore collectively process signals received at antennas in its antenna array using the CSI to distinguish the transmissions from individual access terminals, as discussed in detail below. One advantage to having a large ratio of antennas to access terminals is that simple linear de-coding (e.g., de-multiplexing) can be nearly optimal. Specific linear combinations of the message-bearing signals received by the LSAS base station may yield estimates for the message-bearing signals for the access terminals, where the combining coefficients depend on the channel estimates.

Pilot transmission in the portion 215 is followed by down-link pilot and data transmission in the portions 220, 225, respectively. For example, the LSAS base stations and the small cells may use their knowledge of the channels to the access terminals that they serve to form downlink beams for transmitting low-overhead downlink pilot signals (in portion 220) to inform the access terminals of their channel gain and to transmit their downlink data (in portion 225). The down-link pilot transmission portion 220 may be especially beneficial to the small cell terminals that are served by single-antenna small-cells which would otherwise experience considerable uncertainty as to the gain of their received signals. A large ratio of the number of antennas in the LSAS base station to the number of access terminals may render the linear pre-coding (e.g., multiplexing) used to form the beams nearly optimal. The linear pre-coding operation multiplies a vector of message-bearing signals intended for the access terminals by a matrix, whose elements depend on the channel estimates, to create a vector of signals which the LSAS base station antennas jointly and concurrently transmit. Some embodiments may combine power control with the linear pre-coding of the signals for transmission. The effect of the linear pre-coding is that each access terminal receives the message-bearing signal intended for it with minimal interference from the message-bearing signals that are directed at the other access terminals, as discussed herein.

Referring back to FIG. 1, channel-state information (CSI) (e.g., estimates of propagation channels between antennas in the antenna array 110 and the access terminals 106-109) may be estimated using uplink pilot signals transmitted by the access terminals 106-109 in time slots such as the time slots 205 shown in FIG. 2. The CSI enables the antennas in the antenna array 110 to transmit message-bearing signals over the downlink selectively and concurrently to the access terminals 106-109 using the same time/frequency resources. The CSI estimates also allow the LSAS base station 105 to distinguish message-bearing signals that are transmitted in the same time/frequency bins by the access terminals 106-109.

Since TDD is implemented in the wireless communication system 100, the time needed to acquire CSI is independent of the number of antennas in the antenna array 110. Thus, some embodiments of the LSAS techniques described herein are scalable in an unlimited manner with respect to the number of antennas in the antenna array 110. Increasing the number of antennas in the antenna array 110 can improve multiplexing selectivity and the total radiated power from the antenna array 110 can be reduced in proportion to the number of antennas. Furthermore, when the number of antennas in the antenna array 110 is increased, multiplexing signal processing can become nearly optimal, the effective channel frequency-response may be flattened, power-control may be simplified, and small numbers of expensive ultra-linear electronic devices may be replaced by many low-cost reduced-performance devices.

Some embodiments of the wireless communication system 100 implement orthogonal frequency-division multiplexing (OFDM). For example, each time slot may be partitioned to transmit 14 OFDM symbols on each of a plurality of orthogonal frequencies that are referred to as tones or subcarriers. Propagation channels between the LSAS base station 105 and the access terminals 106-109 may be treated as being piece-wise constant over intervals of 14 tones that are referred to as the frequency-smoothness intervals. In some embodiments, the OFDM parameters (in seconds) may be defined by a symbol interval

$${T}_{s} = \frac{{10}^{- 3}}{14} ,$$

a guard-interval

$${T}_{g} = \frac{{T}_{s}}{15} ,$$

and a usable symbol-interval

$${T}_{u} = {T}_{s} - {T}_{g} = \frac{{10}^{- 3}}{15} .$$

The guard-interval is chosen to be at least as great as the channel delay-spread, T_{d}. In a worst case scenario in which T_{d}=T_{g}, the Nyquist-sampling frequency-interval is equal to the reciprocal of the guard-interval (in hertz) or the frequency-smoothness interval of

$$\frac{{T}_{u}}{{T}_{g}} = 14 ( in tones ) .$$

The equivalent sample-duration of the LSAS time slot, denoted T, is equal to the frequency smoothness interval times the number of OFDM symbols in the slot,

$$T = \frac{{T}_{u}}{{T}_{g}} \frac{{T}_{s 1}}{{T}_{s}} = \frac{14 {T}_{s 1}}{{T}_{s}} \qquad ( 1 )$$

A one millisecond time slot, for example, contains exactly fourteen OFDM symbols, so the sample-duration is T=14×14=196. The slot sample-duration represents the number of independent uses of the channel within each piecewise-constant frequency response interval.

As discussed herein, the LSAS base station 105 derives knowledge of the up-link channels for the antennas in the antenna array 110 (and by virtue of TDD reciprocity knowledge of the down-link channels) from the uplink pilot signals that are transmitted by the access terminals 106-109. In embodiments that implement OFDM, different uplink pilot signals are transmitted at least in each of the tone-intervals in which the frequency-response is approximately piecewise-constant, e.g. in each frequency-smoothness interval. The uplink pilot signals may therefore be indexed by both tone and OFDM symbol because the uplink pilot signals may span more than one OFDM symbol. For a given set of K access terminals 106-109, the most efficient pilot sequences are mutually-orthogonal and have a total sample-duration, τᵣ, greater than or equal to K. In some embodiments, each of the access terminals 106-109 may transmit a one-sample pilot while all other access terminals 106-109 are silent, but the quality of the channel estimates is improved if some or all the access terminals 106-109 concurrently transmit their uplink pilot signals at full power for all τᵣ samples. Thus, harmonically-related orthogonal complex sine-waves make ideal pilot sequences. The access terminals 106-109 transmit their pilot sequences synchronously and the uplink pilot signals received by each antenna in the antenna array 110 is correlated with each of the K pilot sequences. After scaling, the correlation coefficients for each of the K pilot sequences yields an estimate for the channel between each antenna and each access terminal 106-109. The channel estimate for each antenna-access terminal pair is derived independently of the channel estimates for the other antenna-access terminal pairs.

In embodiments where K>τᵣ, the pilot sequences cannot be perfectly orthogonal, and attempts to estimate the channels on the basis of the received pilot signals alone result in correlated channel estimates. For example, the channel estimate to the k-th terminal may be corrupted by a linear combination of channels to all other access terminals 106-109 whose pilot sequences are correlated with the k-th pilot sequence. This correlation, which is sometimes referred to as pilot contamination, results in directed interference when the LSAS base station 105 utilizes the channel estimates for down-link multiplexing and up-link de-multiplexing. For example, in directing a message-bearing symbol to the k-th terminal, the antennas in the antenna array 110 may be inadvertently directing the same symbol to other access terminals 106-109 whose pilot sequences are correlated with the k-th pilot sequence. The power of this directed interference increases with the number of antennas at the same rate as the desired signal.

For a given slot-duration, the maximum number of orthogonal pilot sequences is equal to the sample-duration, T, and using pilots of this duration would leave no slot-time for transmitting data. The slot-duration may not be lengthened arbitrarily because of the mobility of the terminals, i.e., the criteria

$${T}_{s 1} < \frac{λ}{4 v}$$

should be satisfied as discussed above, where v is the speed of the terminals and λ is the wave-length. Therefore the maximum number of access terminals 106-109 that can be served concurrently without incurring pilot contamination may be limited to:

$$K < T = \frac{{T}_{u}}{{T}_{g}} \frac{{T}_{s 1}}{{T}_{s}} < \frac{λ {T}_{u}}{4 {vT}_{g} {T}_{s}} . \qquad ( 2 )$$

The LSAS base station 105 can concurrently decode uplink signals transmitted by the access terminals 106-109 using channel state information derived from the uplink pilot signals. Some embodiments of the K access terminals 106-109 transmit up-link data signals to the LSAS base station 105 synchronously with each other and the LSAS base station 105. For example, the k-th terminal transmits a message-bearing (QAM—quadrature amplitude modulation) symbol, qₖ, times a power-control variable, ηₖ^{1/2}, where, in the interest of clarity, subscripts denoting the tone-index and OFDM symbol-index are suppressed. Collectively the access terminals 106-109 transmit a K×1 vector, sᵣ=D_{η}^{1/2}q, where D_{η}^{1/2} is the K×K diagonal matrix whose diagonal elements are the power-control parameters and q is the K×1 vector of QAM symbols. The antenna array 110 includes M antennas that collectively receive a M×1 vector, xᵣ=\sqrt{ρᵣ}GD_{η}^{1/2}q+wᵣ, where G is a M×K matrix that represents the channel frequency-response between the access terminals 106-109 and the antennas in the antenna array 110, wᵣ represents additive receiver noise and interference, and ρᵣ is a scalar that represents overall channel strength. Again, subscripts denoting tone-index and OFDM symbol-index are suppressed in the interest of clarity.

The matrix-valued propagation channel between the antenna array 110 of the LSAS base station 105 and the access terminals 106-109 mixes the message-bearing symbols together. Some embodiments of the LSAS base station 105 may therefore process the received signal to restore the individual message-bearing symbols. For example, the LSAS base station 105 may multiply the received signal by a K×M de-coding (or de-multiplexing) matrix, which depends on the channel-estimates, \hat{q}=Aᵣxᵣ. A matched filter decoding matrix may be defined as Aᵣ∝Ĝ^{H}, where the superscript “H” denotes “conjugate-transpose.” A zero-forcing decoding matrix may be defined as Aᵣ∝(Ĝ^{H}Ĝ)⁻¹Ĝ^{H}. In the absence of channel-estimation error and noise, zero-forcing will recover the individual QAM symbols perfectly, while matched-filtering requires perfect orthogonality of the channels to the terminals (e.g., the column vectors of G have to be orthogonal) for perfect recovery. The performance gap between matched-filtering and zero-forcing decreases as the number of antennas in the antenna array 110 grows large compared with the number of access terminals 106-109, at least in part because asymptotic orthogonality tends to occur. In some embodiments, matched-filtering may outperform zero-forcing at sufficiently low signal to interference plus noise ratios (SINRs).

An advantage of matched-filtering over zero-forcing is that the former can be realized by a decentralized system architecture whereby each service-antenna processes its own received message-bearing signal independently of the other service-antennas. This lends great resilience to the system—if some of the antennas in the antenna array 110 are lost, the system continues to run without change—and it permits the system to be expanded without significant changes to the existing system.

The LSAS base station 105 can concurrently transmit downlink signals to the access terminals 106-109 over downlink channels estimated based on the channel state information derived from the uplink pilot signals. For example, the antennas in the antenna array 110 may selectively transmit a QAM symbol to each of K access terminals 106-109. The K×1 vector of QAM symbols may be denoted by q, which is multiplied by a M×K pre-coding (multiplexing) matrix, A_{f}, to create the M×1 vector of signals, S_{f}=A_{f}q, that are collectively and concurrently transmitted by the antennas in the antenna array 110. The K access terminals 106-109 receive a K×1 vector, x_{f}=\sqrt{ρ_{f}}G^{T}A_{f}D_{η}^{1/2}q+w_{f}, where w_{f} is additive noise and interference, D_{η}^{1/2} is the K×K diagonal matrix whose diagonal elements are the power-control parameters, and ρ_{f} is a scalar that represents overall channel strength. The pre-coding matrix may correspond to conjugate beam-forming, Aᵣ∝Ĝ*, where the superscript “*” denotes “complex-conjugate”, or zero-forcing, Aᵣ∝Ĝ*(Ĝ^{T}Ĝ)⁻¹. As in the case of up-link data transmission, the asymptotic orthogonality of channels to the access terminals 106-109 increasingly benefits conjugate beam-forming as the number of antennas in the antenna array 110 grows.

Some embodiments of the wireless communication system 100 may operate as part of a cellular communication system. Multi-cellular LSAS operation entails synchronous operations from cell to cell according to the slot structure of FIG. 2, but the operations may be substantially autonomous between the cells, with the possible exception of power control. For example, each LSAS base station such as the LSAS base station 105 shown in FIG. 1, works to transmit QAM symbols over the downlink only to its own access terminals such as the access terminals 106-109. On the up link, each LSAS base station works only to receive the QAM symbols transmitted by its own access terminals. Autonomous operation of the LSAS base stations may give rise to inter-cell interference, which is of two types: non-coherent interference that can be reduced by incorporating extra antennas into the LSAS antenna arrays, and coherent interference, which is not reduced by adding extra antennas to the LSAS antenna arrays.

Coherent inter-cell interference is associated with pilot contamination that may occur when the same pilot sequences are re-used in more than one cell. If two or more access terminals in different cells use the same pilot sequence then the home LSAS base station may obtain a channel estimate for its own access terminal that is corrupted by the channels to access terminals in other cells that use the same pilot sequence. On the down-link, the home LSAS base station may inadvertently transmit coherent interference to these other access terminals, the magnitude of which grows with the number of LSAS antennas at the same rate as the desired signal to the access terminal in the home cell. Similar coherent interference occurs on the up link: while coherently receiving the QAM symbols from its own access terminal, the home LSAS base station is inadvertently coherently receiving transmission from access terminals in other cells that use the same pilot sequence. Some embodiments may mitigate pilot contamination, at the cost of greater pilot transmission overhead, by using a pilot sequence re-use factor that is greater than one. For example if pilot sequences seven times as long as necessary are used, then the home cell may be surrounded by six cells, and within this cluster of seven cells all access terminals can be assigned mutually orthogonal pilot sequences. The home cell may then the surrounded by two concentric rings of cells that inflict only non-coherent interference in the home cell. Pilot contaminating cells are confined to the third ring and beyond.

The theoretical performance of LSAS may be estimated for an embodiment in which a single LSAS array (such as the antenna array 110) is serving a set of access terminals such as the access terminals 106-109. The estimate assumes independent Rayleigh fading with no geometric attenuation or shadow-fading and no power-control. The net down-link throughput per terminal (measured in bits/s/Hz) for conjugate beam-forming and for zero-forcing respectively can be lower-bounded as follows:

$$\begin{matrix}{C}_{CB} > ( 1 - {τ}_{r} / T ) {log}_{2} ( 1 + \frac{M}{K} \frac{{ρ}_{f}}{1 + {ρ}_{f}} \frac{{ρ}_{r} {τ}_{r}}{1 + {ρ}_{r} {τ}_{r}} ) & ( 3 ) \\ {C}_{ZF} > ( 1 - {τ}_{r} / T ) {log}_{2} ( 1 + \frac{M - K}{K} \frac{{ρ}_{f} {ρ}_{r} {τ}_{r}}{1 + {ρ}_{f} + {ρ}_{r} {τ}_{r}} ) , & ( 4 )\end{matrix}$$

where ρ_{f} is the expected SNR at each access terminal if the full down-link transmitted power (independent of the number of antennas in the antenna array) were applied to one of the service-antennas, and ρᵣ is the expected SNR at each antenna if one of the access terminals were transmitting. The second term in the logarithms is the effective SINR at each access terminal. The lower bounds account for: a) the overhead associated with acquiring CSI (the term (1−τᵣ/T) is the fraction of the slot in which down-link data is transmitted), b) the quality of the CSI as represented by the product of the up-link SNR and the pilot-duration, ρᵣτᵣ, and c) the imperfections of the pre-coding. Increasing the number of antennas, M, improves performance, and ρ_{f} (which is proportional to the total down-link radiated power) can be made inversely proportional to M without reducing performance.

Performance bounds similar to those in equations (3) and (4) may also be estimated for up-link LSAS. In some embodiments of the wireless communication system 100, these bounds may be extended to handle very general scenarios entailing a) near-far effects, b) power control, and c) multiple cell operation including both coherent and non-coherent inter-cell interference. These same bounds may be used to implement power control algorithms in the LSAS base station 105. For example, the SINR for transmissions to and from each access terminal 106-109 is an expression in which power control coefficients appear linearly in both the numerator and the denominator. Hence inequality constraints on the SINRs (and therefore on the throughput bounds) such as those in equations (3) and (4) are equivalent to linear inequality constraints on the power control coefficients. Optimum sets of power control coefficients for satisfying specified throughputs are obtained by solving linear programming problems.

The wireless communication system 100 also includes one or more small cells 115. The small cells 115 may also be referred to as home base station routers, microcells, femtocells, picocells, and the like. Embodiments of the small cells 115 may include one or more antennas for providing wireless connectivity to access terminals 106-109 within a geographical area that overlaps or overlays at least a portion of the geographical area served by the LSAS base station 105. The small cell 115 and the LSAS base station 105 operate synchronously with the access terminals 106-109 using the same TDD time slot structure, e.g., the time slots 205 shown in FIG. 2. Consequently, as discussed herein, uplink or downlink transmissions associated with the small cell 115 may collide or interfere with uplink or downlink transmissions associated with the LSAS base station 105.

The LSAS base station 105 may therefore utilize one subspace of channels for transmissions to access terminals assigned to the LSAS base station 105 while nulling a separate, orthogonal, subspace of channels associated with access terminals assigned to the small cell 115. For example, the LSAS base station 105 may transmit downlink signals on a subspace of channels 120, 121, 122 (collectively referred to as “the channels 120-122”) directed towards corresponding access terminals 106-108 concurrently with nulling (indicated by the dashed line) a subspace of channels 125 channel directed to the access terminal 109 associated with the small cell 115. Consequently, the LSAS base station 105 transmits beams to its own access terminals 106-108 without transmitting appreciable power to the access terminals 109 associated with the small cell 115. The small cell 115 can concurrently and synchronously transmit downlink signals to the access terminal 109 using the same time/frequency resources as the LSAS base station 105. For another example, For example, the LSAS base station 105 may receive uplink signals on the subspace of channels 120-122 concurrently with nulling (indicated by the dashed line) the subspace of channels 125 channel directed to the access terminal 109. The small cell 115 can concurrently and synchronously receive uplink signals from the access terminal 109 using the same time/frequency resources as the LSAS base station 105.

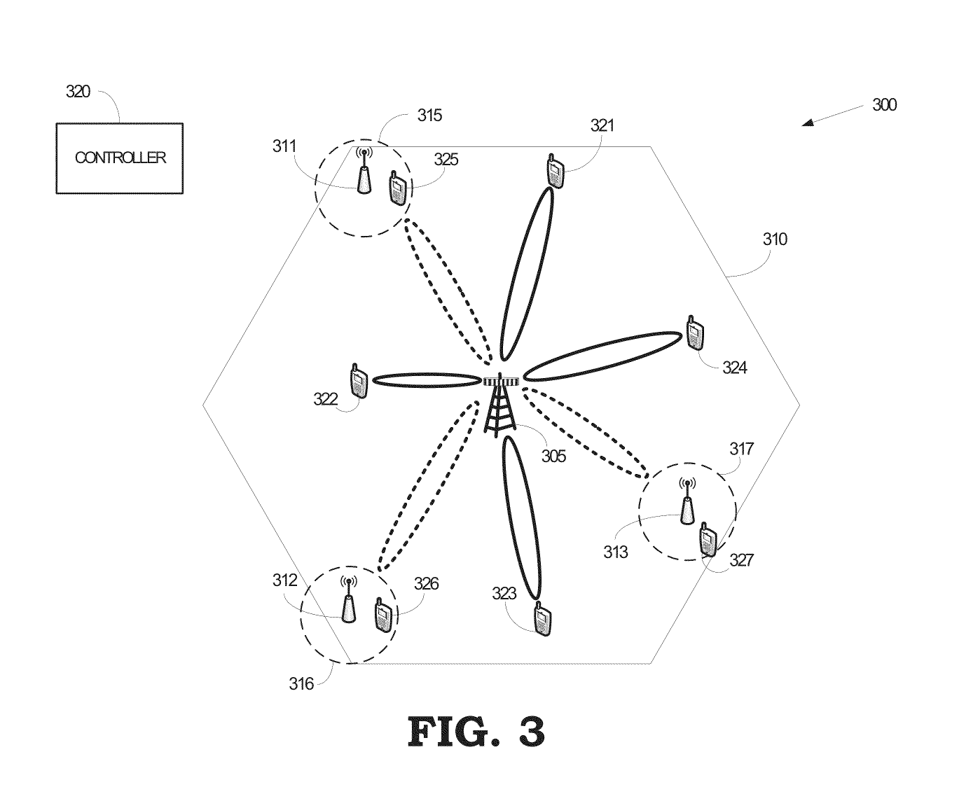

FIG. 3 is a block diagram of a wireless communication system 300 according to some embodiments. The wireless communication system 300 includes an LSAS base station 305 that provides wireless connectivity within a geographic area or cell 310. The wireless communication system 300 also includes small cells 311, 312, 313 (collectively referred to as “the small cells 311-313”) that can provide wireless connectivity within overlapping geographic areas or cells 315, 316, 317 (collectively referred to as “the cells 315-317”). The base station 305 and the small cells 311-313 operate synchronously according to a TDD structure such as the time slot structure 205 shown in FIG. 2.

A controller 320 may be used to coordinate operation of the LSAS base station 305 and the small cells 315-317. In the interest of clarity, connections between the LSAS base station 305 and the small cells 315 are not shown in FIG. 3. Some embodiments of the controller 320 may perform admission control functions for access terminals 321, 322, 323, 324, 325, 326, 327 (collectively referred to as “the access terminals 321-327”). For example, the controller 320 may receive requests from the access terminals 321-327 to access the wireless communication system 300 and may admit or deny the requests based on the number of access terminals 321-327 being served in the cells 310, 315-317. Access may be permitted as long as the number of access terminals 321-327 is less than a threshold value determined by a ratio of the number of access terminals to the number of antennas in an antenna array associated with the LSAS base station 105, as discussed herein. If admitting a new access terminal would decrease this ratio below the threshold value, access may be denied.

Some embodiments of the controller 320 may also partition the access terminals 321-327 by assigning them to the LSAS base station 305 or one of the small cells 311-313. For example, the access terminals 321-324 may be assigned to the LSAS base station 305 and the access terminals 325-327 may be assigned to the small cells 311-313, respectively. Some embodiments of the controller 320 may also assign unique pilot sequences, identifiers, scrambling codes, and the like to the access terminals 321-327. The number of unique pilot sequences may be limited so that the ratio of the number of access terminals that can be uniquely identified does not cause the ratio of access terminals to antennas to exceed the threshold value discussed herein.

During the uplink data transmission phase, e.g., during the uplink data portion 210 shown in FIG. 2, all of the access terminal 321-327, whether served by the LSAS base station 305 or by a small-cell 311-313, transmit message-bearing signals such as QAM symbols synchronously using the same time/frequency resources. In some embodiments, power control coefficients may be applied to the uplink transmissions. The power control coefficients may be determined by the LSAS base station 305, the small cells 311-313, or the controller 320. The small-cells 311-313 may implement a single-antenna matched filter, which entails multiplying their received signal by the complex conjugate of the channel estimate to the corresponding access terminals 325-327. However, some embodiments of the small cells 311-313 may implement more than one antenna and may therefore use different types of filters. The LSAS base station 305 estimates channels to its assigned access terminals 321-324 and the access terminals 325-327 that are assigned to the small cells 311-313. The LSAS base station 305 may therefore perform linear de-coding on the received uplink signals in a spatial diversity subspace (indicated by the solid oval beams) that is orthogonal to a spatial diversity subspace (indicated by the dashed oval beams) spanned by the channels to the access terminals 325-327. This greatly reduces interference to the LSAS terminal transmissions that would otherwise be caused by the small-cell terminal transmissions.

Some embodiments of the LSAS base station 305 may perform the linear decoding in the orthogonal spatial diversity subspace by nulling channels directed towards the access terminal 325-327 during the decoding process (as indicated by the dashed oval beams). For example, let Ĝ_{B} denote the channel estimate to the LSAS terminals 321-324 and let Ĝ_{S} denote the channel estimate to the small-cell terminals 325-327. The LSAS base station 305 may then perform a linear de-coding operation \hat{q}_{B}=Aᵣ(I_{M}−Ĝ_{S}(Ĝ_{S}^{H}Ĝ_{S})⁻¹Ĝ_{S}^{H})xᵣ, where \hat{q}_{B} is the estimate for the vector of LSAS QAM symbols, and as in ordinary LSAS operation Aᵣ is a linear de-coding matrix, typically of the matched-filter type or the zero-forcing type. The term (−Ĝ_{S}(Ĝ_{S}^{H}Ĝ_{S})⁻¹Ĝ_{S}^{H}) represents nulling of the channels associated with the small cell terminals 325-327. The reception of the LSAS QAM symbols from the access terminal 321-324 is therefore nearly immune to interference caused by the up link transmissions of the small-cell terminals 325-327. While this may not directly benefit the small-cell up link transmissions, which may suffer interference from the transmissions of the LSAS terminals 321-324, it does however benefit them indirectly because it may be possible to reduce the uplink transmission powers of the LSAS terminals 321-324.

The LSAS base station 305 and the small cells 311-313 may transmit downlink data concurrently during the downlink data phase, e.g., during the downlink data portion 220 shown in FIG. 2. Some embodiments of the small cells 311-313 may perform single-antenna conjugate beam-forming, with power control, to their respective terminals 325-327. The LSAS base station 305 may perform beam-forming to its own terminals 321-324 (as indicated by the solid oval beams) and transmit the downlink signals in the sub-space that is orthogonal to the channels to the small-cell terminals 325-327 (as indicated by the dashed oval beams). As discussed herein, the LSAS base station 305 can estimate the channels to the access terminals 321-327 using the uplink pilot signals and TDD reciprocity. The linear pre-coding performed by the LSAS base station 305 may take the form s_{f}=(I_{M}−Ĝ_{S}(Ĝ_{S}^{H}Ĝ_{S})⁻¹Ĝ_{S}^{H})*A_{f}q_{B}, where A_{f} is a linear pre-coding matrix, typically of the conjugate-beamforming type or the zero-forcing type. The term (−Ĝ_{S}(Ĝ_{S}^{H}Ĝ_{S})⁻¹Ĝ_{S}^{H}) represents nulling in the direction of the small cell terminals 325-327. In some embodiments, the nulling may be represented by other substantially equivalent mathematical descriptions that permit alternative mathematical operations to null in the direction of the small cell terminals 325-327. For example, either a QR factorization or a singular-value decomposition of the channel estimate matrix to the small-cell terminals 325-327 yields alternative, but equivalent, mathematical expressions for the nulling terms. By nulling in the direction of the small-cell terminals 325-327, the reception of the transmissions to the small-cell terminals 325-327 may become nearly immune to the downlink transmissions from the LSAS base station 305.

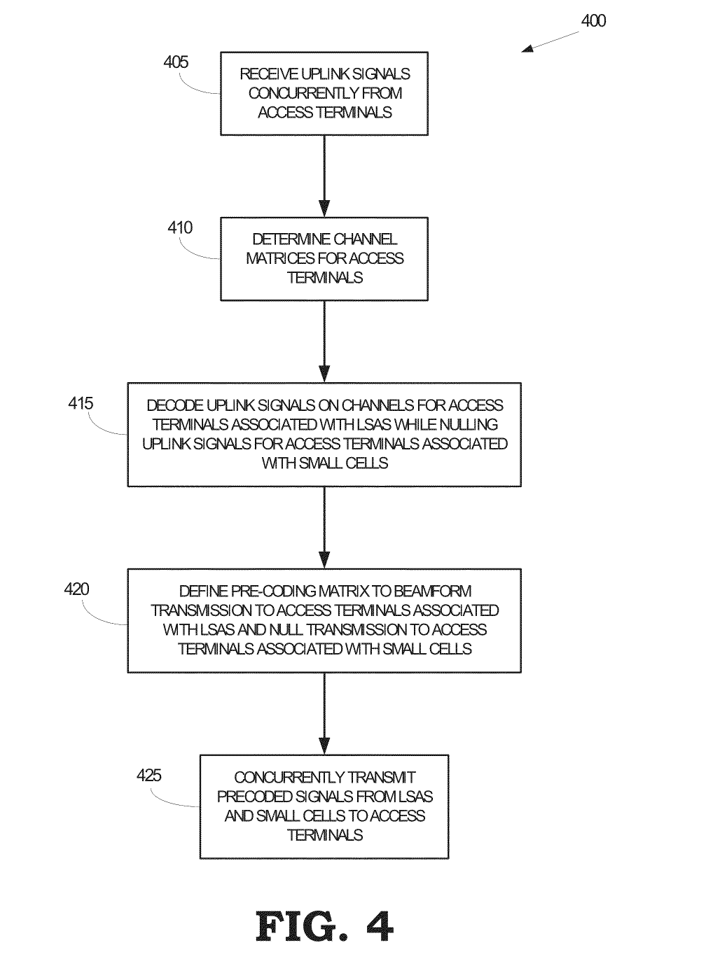

FIG. 4 is a flow diagram of a method 400 for concurrent transmission and reception in a wireless communication system that includes an LSAS base station and one or more overlying small cells according to some embodiments. Embodiments of the method 400 may be implemented in the LSAS base stations 105 and 305 shown in FIG. 1 and FIG. 3, respectively. At block 405, the LSAS base station receives uplink signals concurrently from one or more access terminals. The uplink signals include uplink data signals and uplink pilot signals such as the uplink signals transmitted in the portions 210, 215 of the slots 205 shown in FIG. 2. The uplink signals may be transmitted synchronously by access terminals associated with the LSAS base station and access terminals associated with the small cell(s). At block 410, the LSAS base station determines channel matrices for the channels to the access terminals. The LSAS base station may then decode the uplink signals on channels for access terminals that are associated with the LSAS base station while nulling channels for access terminals that are associated with the small cell(s), at block 415.

At block 420, the LSAS base station may define a pre-coding matrix that can be used to beamform transmission for the access terminals associated with the LSAS base station. The pre-coding matrix may also be defined to null transmission towards access terminals associated with the small cell(s). At block 425, the LSAS base station transmits the precoded signals over the air interface concurrently and synchronously with downlink signals transmitted from the small cell(s) to their associated access terminals. The downlink signals include downlink data signals and downlink pilot signals such as the downlink signals transmitted in the portions 220, 225 of the slots 205 shown in FIG. 2. The LSAS base station and the small cell(s) may therefore use the same time/frequency resources for the downlink transmissions.

In some embodiments, certain aspects of the techniques described above may implemented by one or more processors of a processing system executing software. The software comprises one or more sets of executable instructions stored or otherwise tangibly embodied on a non-transitory computer readable medium. The software can include the instructions and certain data that, when executed by the one or more processors, manipulate the one or more processors to perform one or more aspects of the techniques described above. The non-transitory computer readable medium can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)). The executable instructions stored on the non-transitory computer readable medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
transmitting, from a large-scale antenna system (LSAS) base station, at least one first signal on at least one first channel corresponding to at least one first access terminal associated with the LSAS base station concurrently with nulling at least one second channel corresponding to at least one second access terminal associated with at least one small cell, wherein said at least one first signal is transmitted synchronously with at least one second signal transmitted by said at least one small cell.

2. The method of claim 1, further comprising:
estimating said at least one first channel based on at least one first pilot signal received at the LSAS base station from said at least one first access terminal; and
estimating said at least one second channel based on at least one second pilot signal received at the LSAS base station from said at least one second access terminal.

3. The method of claim 2, wherein estimating said at least one first channel comprises detecting said at least one first pilot signal based on at least one first orthogonal code assigned to said at least one first access terminal, and wherein estimating said at least one second channel comprises detecting said at least one second pilot signal based on at least one second orthogonal code assigned to said at least one second access terminal.

4. The method of claim 2, further comprising:
allocating power for transmitting said at least one first signal based on said at least one first pilot signal and said at least one second pilot signal.

5. The method of claim 2, further comprising:
allocating unique identifiers to said at least one first access terminal and said at least one second access terminal, wherein the LSAS base station is to distinguish between said at least one first pilot signal and said at least one second pilot signal on the basis of the unique identifiers.

6. The method of claim 1, wherein transmitting said at least one first signal comprises concurrently transmitting a plurality of first signals on a plurality of first channels corresponding to a plurality of first access terminals associated with the LSAS base station concurrently with nulling said at least one second channel.

7. The method of claim 1, further comprising:
receiving, at the LSAS base station, at least one third signal on said at least one first channel concurrently with nulling said at least one second channel.

8. The method of claim 1, wherein transmitting said at least one first signal comprises transmitting said at least one first signal using a number of antennas associated with the LSAS base station that is larger than a sum of a number of said at least one first access terminal and said at least one second access terminal.

9. The method of claim 1, further comprising:
assigning said at least one first access terminal to the LSAS base station; and
assigning said at least one second access terminal to said at least one small cell.

10. An apparatus, comprising:
a large-scale antenna system (LSAS) base station to transmit at least one first signal on at least one first channel corresponding to at least one first access terminal associated with the LSAS base station concurrently with nulling at least one second channel corresponding to at least one second access terminal associated with at least one small cell, wherein said at least one first signal is transmitted synchronously with at least one second signal transmitted by said at least one small cell.

11. The apparatus of claim 10, further comprising:
a plurality of antennas coupled to the LSAS base station to transmit said at least first one signal, wherein a number of the plurality of antennas is larger than a sum of a number of said at least one first access terminal and a number of said at least one second access terminal.

12. The apparatus of claim 10, wherein the LSAS base station is to estimate said at least one first channel based on at least one first pilot signal received at the LSAS base station from said at least one first access terminal and estimate said at least one second channel based on at least one second pilot signal received at the LSAS base station from said at least one second access terminal.

13. The apparatus of claim 12, wherein the LSAS base station is to detect said at least one first pilot signal based on at least one first orthogonal code assigned to said at least one first access terminal and detect said at least one second pilot signal based on at least one second orthogonal code assigned to said at least one second access terminal.

14. The apparatus of claim 12, wherein the LSAS base station is to allocate power for transmitting said at least one first signal based on said at least one first pilot signal and said at least one second pilot signal.

15. The apparatus of claim 12, wherein unique identifiers are allocated to said at least one first access terminal and said at least one second access terminal, and wherein the LSAS base station is to distinguish between said at least one first pilot signal and said at least one second pilot signal on the basis of the unique identifiers.

16. The apparatus of claim 10, wherein the LSAS base station is to concurrently transmit a plurality of first signals on a plurality of first channels corresponding to a plurality of first access terminals associated with the LSAS base station concurrently with nulling said at least one second channel.

17. The apparatus of claim 10, wherein the LSAS base station is to receive at least one third signal on said at least one first channel concurrently with nulling said at least one second channel.

18. The apparatus of claim 10, wherein said at least one first access terminal is assigned to the LSAS base station and said at least one second access terminal is assigned to said at least one small cell.

19. A non-transitory computer readable medium embodying a set of executable instructions, the set of executable instructions to manipulate a large-scale antenna system (LSAS) base station to:
transmit at least one first signal on at least one first channel corresponding to at least one first access terminal associated with the LSAS base station concurrently with nulling at least one second channel corresponding to at least one second access terminal associated with at least one small cell, wherein said at least one first signal is transmitted synchronously with at least one second signal transmitted by said at least one small cell.

20. The non-transitory computer readable medium of claim 19, embodying a set of executable instructions to manipulate the LSAS base station to receive at least one third signal on said at least one first channel concurrently with nulling said at least one second channel.
